(19) United States
(12) Patent Application Publication
(10) Pub. No.: US 2009/0226572 A1
(43) Pub. Date: Sep. 10, 2009

(54) Edible containers having beneficial gas

(76) Inventors: Leonid Danushevsky, Riverwoods, IL (US); David Danushevsky, San Diego, CA (US)

Correspondence Address: Michael S. Leonard;EVEREST INTELLECTUAL PROPERTY LAW GROUP, P.O. Box 708, Northbrook, IL, 60065, US

(21) Appl. No.: 12/075,254

(22) Filed: Mar. 10, 2008

(51) Int. Cl. A23L 1/30

(52) U.S. Cl. 426/96

(57) ABSTRACT

A device for use in the mouth of a user has an edible object capable of deformation in the mouth of the user. A beneficial gas is contained in the edible object. The edible object is deformed in the mouth of the user during use of the device and the beneficial gas is released from the deformed edible object into the mouth of the user. The user can inhale the beneficial gas and receive its benefits.

### BACKGROUND OF THE INVENTION

The present invention pertains to containers having a beneficial gas. The containers having the beneficial gas are intended to be placed in the mouth of the user and deformed to release the beneficial gas. The gas released from the container can provide a benefit, for example an energy boost, to the user. Also, the containers can be edible and consumed by the user. The present invention also pertains to containers, such as edible containers, that have a gas producing component. The gas producing component is activated in the mouth of the user and produces a beneficial gas in the mouth of the user. The present invention also pertains to methods of delivering beneficial gas to a user.

The present invention will be described in an embodiment of the beneficial gas providing an energy boost to the user. Oxygen gas may provide such an energy boost to the user. However, the present invention is broader than energy boosting gas and is not limited to energy boosting gas. The present invention can be practiced in many different embodiments having numerous different containers and numerous different gasses. Embodiments of the present invention can also include other desired or beneficial components that can be delivered to the user.

There are many needs to provide beneficial substances to users. For example, there are widespread needs to consume energy boosting substances. The widespread needs for energy boosting substances is clearly evident by the numerous energy boosting beverages that are available. However, energy boosting beverages have limitations. Energy boosting beverages are liquids and must be consumed by drinking over a relatively long time period. Energy boosting beverages are packaged in a large liquid containers which must be disposed of after the beverage is consumed. The large containers become undesirable trash after the beverage is consumed and may be environmentally unfriendly. Energy boosting beverages are typically available in relatively large liquid volumes, such as approximately 10-16 ounces. Also, energy boosting beverages have been limited to liquids held in liquid containers, such as cans and the like.

Therefore, needs exist to provide other devices and methods for delivering beneficial substances, such as energy boosting substances and other substances, to users. The needs exist for the reasons mentioned above and for other reasons.

### SUMMARY OF THE INVENTION

The present invention provides new edible containers that deliver beneficial gas to a user. In an embodiment of the present invention, an edible container has a beneficial gas. The edible container having the beneficial gas can be placed in the mouth of the user and deformed to release the beneficial gas. The user can then inhale the released gas. The gas released from the edible container can provide a benefit, for example an energy boost, to the user. Also, the edible container can be consumed by the user.

In another embodiment of the present invention, an edible container has a gas producing component. The edible container is deformed in the mouth of the user and the gas producing component is activated in the mouth of the user by a reaction process. The activated gas producing component produces a beneficial gas in the mouth of the user which can be inhaled by the user. The present invention also pertains to methods of delivering beneficial gas to a user.

In an embodiment, a device for use in the mouth of a user has an edible object capable of deformation in the mouth of the user. A beneficial gas is contained in the edible object. During use of the device, the edible object is deformed in the mouth of the user and the beneficial gas is released from the deformed edible object into the mouth of the user.

The beneficial gas can be an energy boosting gas, for example, oxygen.

The edible object can have a closed chamber containing the beneficial gas prior to deformation. The beneficial gas can be dispersed in at least a portion of the edible object rather than contained in a closed chamber. The edible container can be dissolvable in the mouth of the user. The edible container can be fracturable in the mouth of the user.

The edible container can be a pill. The edible container can substantially comprise a naturally occurring edible item.

In another embodiment of the present invention, an edible item has an edible object, and a gas component contained in the edible object.

The gas component can be a gas or a gas producer that produces a gas by a reaction process.

The edible object can be dissolvable in a mouth of a user or fracturable in the mouth of the user.

In another embodiment of the present invention, a method of delivering a gas to a user includes placing an edible object in a mouth of the user, releasing a gas agent from the edible object into the mouth of the user, and providing the gas in the mouth of the user.

The step of releasing a gas agent from the edible object into the mouth of the user can include releasing the gas directly from the edible object.

Features of the present invention may be described in certain embodiments. However, the present invention is broader than the described embodiments. Embodiments of the present invention may have various features and provide various advantages. Any of the features and advantages of the present invention may be desired, but, are not necessarily required to practice the present invention.

Advantages of the present invention can be to provide new edible containers or devices that provide a beneficial gas to the user.

Another advantage of the present invention can be to provide new methods of providing gasses to a user.

A further advantage of the present invention can be to deliver energy boosting gas to a user.

Yet another advantage of the present invention can be to contain a beneficial gas in an edible object.

Another advantage of the present invention can be to provide new edible containers having a gas producing component or agent that produces a gas upon reaction in the user's mouth.

Additional features and advantages of the present invention are described in, and will be apparent from, the following Detailed Description of the Invention and the figures.

### BRIEF DESCRIPTION OF THE FIGURES

FIG. 1 is a cross-sectional view of an edible container having a beneficial gas according to the present invention.

FIG. 2 is a perspective view of another edible container having a beneficial gas.

FIG. 3 is a perspective view of another edible container having a beneficial gas.

FIG. 4 is a cross-sectional view of another edible container having a beneficial gas or a gas producer.

### DETAILED DESCRIPTION OF THE INVENTION

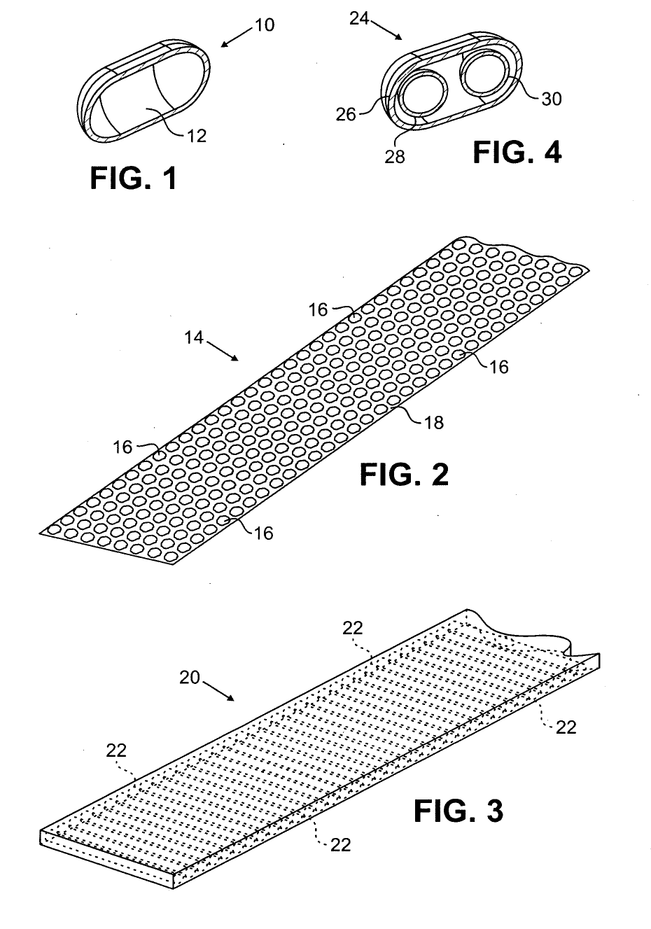

One example of an edible container 10 or device having a beneficial gas according to the present invention is shown in FIG. 1. The edible container 10 of FIG. 1 can be a hollow pill, such as a capsule or the like, having a closed chamber or pocket 12. FIG. 1 is a cross-sectional view of the edible container 10 and shows one-half of the container 10. The other half (not shown) of the edible container 10 is a mirror image of what is shown in FIG. 1. The closed chamber 12 contains the beneficial gas, such as oxygen. The edible container 10 is used by placing the edible container 10 in the mouth of the user. The edible container 10 is deformed in the mouth of the user, for example, by dissolving or being chewed and fractured. The deformed edible container 10 releases the beneficial gas into the mouth of the user. The user can inhale the beneficial gas and receive the benefits of the gas.

FIG. 2 shows another example of an edible container 14 having a beneficial gas according to the present invention. The edible container 14 of FIG. 2 has the beneficial gas contained in a plurality of bubbles 16 or a bubble field. The edible container 14 can have a strip-like shape and can be relatively flat, such as a sheet or film. The bubbles 16 are shown in FIG. 2 as protruding from a front surface 18 of the edible container 14. However, the bubbles 16 could be contained within the material of the edible container 14 such that the front and rear sides of the edible container 14 are smooth or at least do not have projecting gas bubbles 16. The bubbles 16 can be dispersed throughout the entire edible container 14 or only a portion of the edible container 14. The bubbles 16 can have any shape and size as desired. Also, the bubbles 16 can be defined by the material of the edible container 14 or separately from the edible container 14 and then attached to the edible container 14 or inserted into the edible container 14. All of the bubbles 16 can contain the same energy gas. Alternatively, different bubbles 16 or groups of bubbles 16 can contain different substances, such as different energy gasses or other substances. FIG. 2 shows the bubbles 16 in a particular pattern. However, the bubbles 16 can be arranged in any other pattern or multiple patterns or randomly. As the edible container 14 is deformed, by being chewed and/or dissolved, the beneficial gas is released from the bubbles 16 into the user's mouth. Again, the user can inhale the released gas and receive the benefits of the gas. Some examples of the edible container 14 of FIG. 2 include, without limitation, edible film-like items, strip-shaped candy, taffy, and beef jerky.

FIG. 3 shows another example of an edible container 20 having a beneficial gas according to the present invention. The edible container 20 of FIG. 3 is similar to the edible container 14 of FIG. 2. However, the edible container 20 of FIG. 3 has elongated pockets 22 containing the beneficial gas. Also, the elongated pockets 22 are contained within the material of the edible container 20 rather than projecting outward from the front and/or rear surface of the edible container 20. The material of the edible container 20 can be thicker than the material of the edible container 14 of FIG. 2 if needed to accommodate the size of the elongated pockets 22. The elongated pockets 22 can be dispersed throughout the entire edible container 20 or only a portion of the edible container 20. The elongated pockets 22 can have any shape and size as desired and do not have to be shaped as shown in FIG. 3. Also, the elongated pockets 22 can be defined by the material of the edible container 20 or separately from the edible container 20 and then attached to the edible container 20 or inserted into the edible container 20. All of the elongated pockets 22 can contain the same energy gas. Alternatively, different elongated pockets 22 or groups of elongated pockets 22 can contain different substances, such as different energy gasses or other substances. FIG. 3 shows the elongated pockets 22 in a particular pattern. However, the elongated pockets 22 can be arranged in any other pattern or multiple patterns or randomly.

FIG. 4 shows another embodiment of the present invention. FIG. 4 shows an edible container 24 having an outer shell 26 and closed compartments or chambers 28, 30 contained inside of the outer shell 26. FIG. 4 is a cross-sectional view of the edible container 24 and shows one-half of the edible container 24. The other half (not shown) of the edible container 24 is a mirror image of what is shown in FIG. 4. The edible container 24 of FIG. 4 can be similar to the edible container 10 of FIG. 1, for example, a hollow pill, such as a capsule or the like. FIG. 4 shows the edible container 24 having two chambers 28, 30 inside of the outer shell 26. However, the edible container 24 may have only one closed chamber or any number of closed chambers inside of the outer shell 26. The edible container 24 may not contain a beneficial gas directly. Rather, the edible container 24 may contain one or more components, called a gas producer, that can react when activated to produce the beneficial gas by a reaction process. For example, the closed chambers 28, may each contain a separate gas producer component. When the edible container 24 is placed in the user's mouth and deformed the closed chambers 28, 30 are broken and the gas producer components come into contact with each other and react to produce a beneficial gas within the user's mouth. Again, the user can then inhale the beneficial gas.

As with other embodiments of the present invention, there are many different embodiment variations of the edible container 24 of FIG. 4. As mentioned above, the edible container 24 may have only one closed chamber or any number of closed chambers inside of the outer shell. The gas producer contained in the edible container 24 may be a single component contained in one or more closed chambers that reacts with a user's saliva in the user's mouth to produce the beneficial gas. The gas producer can include any number of components which may be contained in any number of closed chambers having any size and shape. Also, the space outside of the closed chambers 28, 30 and inside of the outer shell 26 can be considered a closed chamber and contain any desired substance. Furthermore, one or more closed chambers could contain a beneficial gas itself or difference gasses or other substances.

Numerous different containers can be suitable for use with different embodiments of the present invention. The containers are edible which means they are suitable for use in a user's mouth. The edible containers can be deformed in the user's mouth, for example by chewing or by being dissolved or a combination thereof. The edible containers may actually be swallowed by the user or may be chewed without swallowing and then discarded from the user's mouth. The edible containers can be substantially naturally occurring, such as caviar, for example. Other suitable containers can include processed food items and man-made edible items. The edible containers are also referred to as edible objects. Examples of edible containers include, without limitation, pills, natural foods, processed foods, caviars, candies, chocolates, chewing gums.

Numerous different gasses can be suitable for use with different embodiments of the present invention. The gasses are intended to be beneficial to the user, but a noticeable or measurable benefit to the user is not necessarily required to practice the present invention. Examples of benefits that may be received from the gas can include, for example without limitation, enhanced energy, increased alertness, and increased awakeness. The gasses can be naturally occurring gases or gasses made by appropriate processing. An edible container can contain a single beneficial gas or any combination of different gasses. One suitable gas for use with the present invention is oxygen.

The beneficial gas can be inserted into the edible container by many different methods or processes. For example, the beneficial gas can be injected into the edible container. A needle or other suitable injection device can be used to inject the beneficial gas into the edible container. Caviar, for example, can be injected with the beneficial gas by using a needle. Another example of providing the beneficial gas in the edible container is to form a chamber or pocket in the edible container and to fill the chamber with the beneficial gas. The chamber must be maintained sealed closed in the end product to retain the beneficial gas within the edible container. Another example of providing the beneficial gas to the edible container is to form a beneficial gas containing pocket separately from the material of the edible container. The beneficial gas containing pocket can then be attached to or inserted into the material of the edible container. Another example of providing the beneficial gas to the edible container is to subject the edible container to a gas environment such that the beneficial gas is absorbed into at least a portion of the edible container.

The terms gas component and gas agent are also used in this disclosure. In embodiments of the present invention, the terms gas component and gas agent can pertain to a gas itself and/or a gas producer which produces a gas by a reaction process.

The present invention can be made to have any taste as desired, including natural and artificial flavors.

Embodiments of the present invention can also include other desired or beneficial components that can be delivered to the user. The additional components can be in any desired form, such as gasses, liquids, solids, gels, etc.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A device for use in the mouth of a user, comprising:
an edible object capable of deformation in the mouth of the user; and
a beneficial gas contained in the edible object;
wherein during use of the device the edible object is deformed in the mouth of the user and the beneficial gas is released from the deformed edible object into the mouth of the user.

2. The device of claim 1, wherein the beneficial gas is an energy boosting gas.

3. The device of claim 1, wherein the beneficial gas is oxygen.

4. The device of claim 1, wherein the edible object has a closed chamber containing the beneficial gas prior to deformation.

5. The device of claim 1, wherein the beneficial gas is dispersed in at least a portion of the edible object.

6. The device of claim 1, wherein the edible container is dissolvable in the mouth of the user.

7. The device of claim 1, wherein the edible container is fracturable in the mouth of the user.

8. The device of claim 1, wherein the edible container comprises a pill.

9. The device of claim 1, wherein the edible container substantially comprises a naturally occurring edible item.

10. An edible item, comprising:
an edible object; and
a gas component contained in the edible object.

11. The edible item of claim 10, wherein the gas component is a gas.

12. The edible item of claim 10, wherein the gas component comprises a gas producer that produces a gas by a reaction process.

13. The edible item of claim 10, wherein the edible object is dissolvable in a mouth of a user.

14. The edible item of claim 10, wherein the edible object is fracturable in a mouth of a user.

15. A method of delivering a gas to a user, comprising:
placing an edible object in a mouth of the user;
releasing a gas agent from the edible object into the mouth of the user; and
providing the gas in the mouth of the user.

16. The method of delivering a gas to a user of claim 15, wherein releasing a gas agent from the edible object into the mouth of the user comprises releasing the gas directly from the edible object.
